(19) United States
(12) Patent Application Publication
(10) Pub. No.: US 2008/0043211 A1
(43) Pub. Date: Feb. 21, 2008

(54) Apparatus and methods for recovering fluid in immersion lithography

(75) Inventors: Alex Ka Tim Poon, San Ramon, CA (US); Leonard Wai Fung Kho, San Francisco, CA (US); Gaurav Keswani, Milpitas, CA (US); Derek Coon, Redwood City, CA (US)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 11/889,893

(22) Filed: Aug. 17, 2007

Related U.S. Application Data
(60) Provisional application No. 60/838,897, filed on Aug. 21, 2006.
(60) Provisional application No. 60/854,442, filed on Oct. 26, 2006.
(60) Provisional application No. 60/854,728, filed on Oct. 27, 2006.

(51) Int. Cl. G03B 27/42

(52) U.S. Cl. 355/30

(57) ABSTRACT

Immersion liquid is recovered in an immersion lithography apparatus. A confinement member includes first and second outlets, each of which recovers an immersion liquid from an immersion area including a gap between a projection system and an object. The second outlet is radially farther from the gap than the first outlet. A porous member covers the second outlet. The first outlet is not covered by any porous member. A first low pressure provided to the first outlet causes more than 50% of recovered immersion liquid to flow through the first outlet. A second low pressure provided to the second outlet maintains a pressure at a surface of the porous member below the porous member's bubble point. A porous member can be disposed on the substrate-holding table adjacent the substrate holding area. Immersion liquid overflowing from the substrate is collected by the porous member.

### CROSS-REFERENCE TO RELATED APPLICATIONS

This application claims the benefit of U.S. Provisional Patent Application No. 60/838,897 filed Aug. 21, 2006, U.S. Provisional Patent Application No. 60/854,442 filed Oct. 26, 2006 and U.S. Provisional Patent Application No. 60/854,728 filed Oct. 27, 2006. The disclosure of each of these applications is incorporated herein by reference in its entirety.

### BACKGROUND

The invention relates to immersion lithography apparatus and methods, and particularly to apparatus and methods for recovering immersion fluid.

A typical lithography apparatus includes a radiation source, a projection optical system and a substrate stage to support and move a substrate to be imaged. A radiation-sensitive material, such as a resist, is coated onto the substrate surface before the substrate is placed on the substrate stage. During operation, radiation energy from the radiation source is used to project an image defined by an imaging element through the projection optical system onto the substrate. The projection optical system typically includes a plurality of lenses. The lens or optical element closest to the substrate can be referred to as the last or final optical element.

The projection area during exposure is typically much smaller than the surface of the substrate. The substrate therefore is moved relative to the projection optical system in order to pattern the entire surface of the substrate. In the semiconductor industry, two types of lithography apparatus are commonly used. With so-called “step-and-repeat” apparatus, the entire image pattern is projected at one moment in a single exposure onto a target area of the substrate. After the exposure, the substrate is moved or “stepped” in the X and/or Y direction(s) and a new target area is exposed. This step-and-repeat process is performed multiple times until the entire substrate surface is exposed. With scanning type lithography apparatus, the target area is exposed in a continuous or “scanning” motion. For example, when the image is projected by transmitting light through a reticle or mask, the reticle or mask is moved in one direction while the substrate is moved in either the same or the opposite direction during exposure of one target area. The substrate is then moved in the X and/or Y direction(s) to the next scanned target area. The process is repeated until all of the desired target areas on the substrate have been exposed.

Lithography apparatus are typically used to image or pattern semiconductor wafers and flat panel displays. The word “substrate” as used herein is intended to generically mean any work piece that can be patterned including, but not limited to, semiconductor wafers and flat panel displays.

Immersion lithography is a technique that can enhance the resolution of lithography exposure apparatus by permitting exposure to take place with a numerical aperture (NA) that is greater than the NA that can be achieved in conventional “dry” lithography exposure apparatus. By filling the space between the final optical element of the projection system and the resist-coated substrate, immersion lithography permits exposure with light that would otherwise be internally reflected at the optic-air interface. Numerical apertures as high as the index of the immersion fluid (or of the resist or lens material, whichever is least) are possible in immersion lithography systems. Liquid immersion also increases the substrate depth-of-focus, that is, the tolerable error in the vertical position of the substrate, by the index of the immersion fluid compared to a dry system having the same numerical aperture. Immersion lithography thus can provide resolution enhancement without actually decreasing the exposure light wavelength. Thus, unlike a shift in the exposure light wavelength, the use of immersion would not require the development of new light sources, optical materials (for the illumination and projection systems) or coatings, and can allow the use of the same or similar resists as conventional “dry” lithography at the same wavelength. In an immersion system in which only the final optical element of the projection system and its housing and the substrate (and perhaps portions of the stage as well) are in contact with the immersion fluid, much of the technology and design developed for dry lithography can carry over directly to immersion lithography.

However, because the substrate moves rapidly in a typical lithography system, the immersion fluid in the immersion area including the space between the projection system and the substrate tends to be carried away from the immersion area. If the immersion fluid escapes from the immersion area, that fluid can interfere with operation of other components of the lithography system. One way to recover the immersion fluid and prevent the immersion fluid from contaminating the immersion lithography system is described in US2006/0152697 A1, the disclosure of which is incorporated herein by reference in its entirety.

It also is known to maintain the immersion fluid in the gap between the last optical element and the imaging surface of the substrate by submerging both in the immersion fluid. For an example of such a system, see, for example, U.S. Pat. No. 4,509,852, the disclosure of which is incorporated herein by reference in its entirety.

### SUMMARY

According to some aspects of the invention, an immersion liquid confinement apparatus confines an immersion liquid in an immersion area that includes a gap between a projection system and an object of exposure in an immersion lithography system. The confinement apparatus also recovers the immersion liquid from the immersion area. The confinement member includes a first outlet and a second outlet. The second outlet is disposed radially farther away from the gap than is the first outlet. A porous member is disposed to cover the second outlet, but the first outlet is not covered by any porous member. A pressure control system controls a first low pressure that is provided to the first outlet so that more than 50% of recovered immersion liquid is recovered through the first outlet. The pressure control system also controls a second low pressure provided to the second outlet. The second low pressure maintains a pressure at a surface of the porous member below a bubble point of the porous member.

According to some embodiments, the first and second outlets each include a groove. In particular, the first and second outlets can include a plurality of openings that open into their corresponding groove. This structure evenly distributes the recovery forces around the gap so as to provide a more uniform flow.

According to some embodiments, the grooves and the porous member encircle the gap.

The porous member can be a mesh, a porous material or a member having etched holes therein. A pore size of the pores in the porous member can be between about 5 μm and 125 μm. By recovering most of the immersion liquid through the first (inner) outlet, less immersion liquid is recovered through the porous member, which enables the pore size of the porous member to be reduced. This enables the bubble point of the porous member to be increased, which reduces the possibility of gas being sucked through the porous member, which can lead to vibration of the confinement member, immersion liquid and projection system.

According to some embodiments, the liquid confinement member also includes one or more immersion liquid supply openings that supply the immersion liquid to the immersion area. The supply openings are disposed closer to the gap than are the first and second outlets.

According to other embodiments of the invention, a porous member can be disposed on the substrate-holding table directly adjacent to the area where the substrate is held. Any immersion liquid that overflows from the substrate is absorbed by the porous member. The porous member can be connected to a receptacle for receiving the immersion liquid, and that receptacle can be communicated with a vacuum source, for example. According to some embodiments, the porous member is disposed on a fine-movement stage, and any immersion liquid collected by the porous member passes through the fine-movement stage and is collected by a second porous member disposed on a coarse-movement stage that is disposed below the fine-movement stage. The immersion liquid collected by the porous member on the fine-movement stage can flow, for example, by gravity to the porous member on the coarse-movement stage which, in turn, is coupled to the receptacle and vacuum source.

### BRIEF DESCRIPTION OF THE DRAWINGS

The invention will be described in conjunction with the following drawings of exemplary embodiments in which like reference numerals designate like elements, and in which:

FIG. 1 is a simplified elevational view schematically illustrating an immersion lithography system according to some embodiments of the invention;

FIG. 2 is a diagram illustrating a liquid confinement and recovery apparatus according to one embodiment of the invention in which first and second liquid outlets are provided in the liquid confinement and recover apparatus;

FIG. 3 is a view showing the lower surface of the FIG. 2 liquid confinement and recovery apparatus (the porous member being omitted from the drawing);

FIG. 4 is a diagram similar to FIG. 2 showing the manner in which the immersion liquid will move when the substrate is moved;

FIG. 5 is a perspective view of an embodiment in which a porous member is disposed adjacent to a substrate on a substrate-holding table;

FIG. 6 is a partial cross-sectional view of the FIG. 5 table;

FIG. 7 shows an embodiment similar to FIG. 5 except that the immersion apparatus has a confinement plate that causes the entire substrate to be covered by immersion liquid;

FIG. 8 illustrates an arrangement in which immersion liquid collected by a porous member on a fine-movement stage is transferred to a second porous member disposed on a coarse movement stage;

FIG. 9A is a flowchart that outlines a process for manufacturing a device in accordance with the invention;

FIG. 9B is a flowchart that outlines device processing in more detail;

FIG. 10 shows an embodiment similar to FIG. 7 except that the confinement plate has first and second liquid outlets similar to FIG. 2; and

FIG. 11 shows an embodiment similar to FIG. 8 except that the apparatus has the confinement plate of FIG. 7.

### DETAILED DESCRIPTION OF EMBODIMENTS

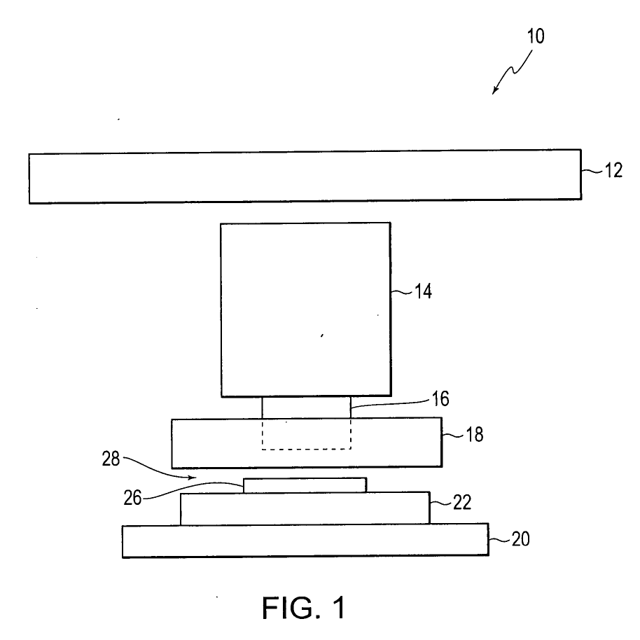

FIG. 1 shows an immersion lithography system 10 including a reticle stage 12 on which a reticle is supported, a projection system 14 having a last or “final” optical element 16, and a fine-movement stage 22 on which a substrate 26 is supported, which in turn is movable over a coarse-movement stage 20. An immersion fluid supply and recovery apparatus 18, which is sometimes referred to herein as an immersion fluid supply and recovery nozzle, is disposed around the final optical element 16 of the projection system 14 so as to provide and recover an immersion fluid, which may be a liquid such as, for example, water, to/from a gap 28 between the final optical element 16 and the substrate 26. In the present embodiment, the immersion lithography system 10 is a scanning lithography system in which the reticle and the substrate 26 are moved synchronously in respective scanning directions during a scanning exposure operation. The fine-movement stage 22 controls the position of the substrate 26 in one or more (preferably all) of the X, Y, Z, θX, θY and θZ directions with a higher degree of precision than the coarse-movement stage 20, which is primarily used for moving the substrate 26 over longer distances, as is well known in the art.

The illumination source of the lithography system can be a light source such as, for example, a mercury g-line source (436 nm) or i-line source (365 nm), a KrF excimer laser (248 nm), an ArF excimer laser (193 nm) or a F₂ laser (157 nm). The projection system 14 projects and/or focuses the light passing through the reticle onto the substrate 26. Depending upon the design of the exposure apparatus, the projection system 14 can magnify or reduce the image illuminated on the reticle. It also could be a 1× magnification system.

When far ultraviolet radiation such as from the excimer laser is used, glass materials such as silica glass and calcium fluorite that transmit far ultraviolet rays can be used in the projection system 14. The projection system 14 can be a catadioptric, completely refractive or completely reflective.

With an exposure device, use of the catadioptric type optical system can be considered. Examples of the catadioptric type of optical system are shown in U.S. Pat. No. 5,668,672 and U.S. Pat. No. 5,835,275. In these cases, the reflecting optical device can be a catadioptric optical system incorporating a beam splitter and concave mirror. U.S. Pat. No. 5,689,377 also uses a reflective-refracting type of optical system incorporating a concave mirror, etc., but without a beam splitter, and also can be employed with this invention. The disclosures of the above-mentioned U.S. patents are incorporated herein by reference in their entireties.

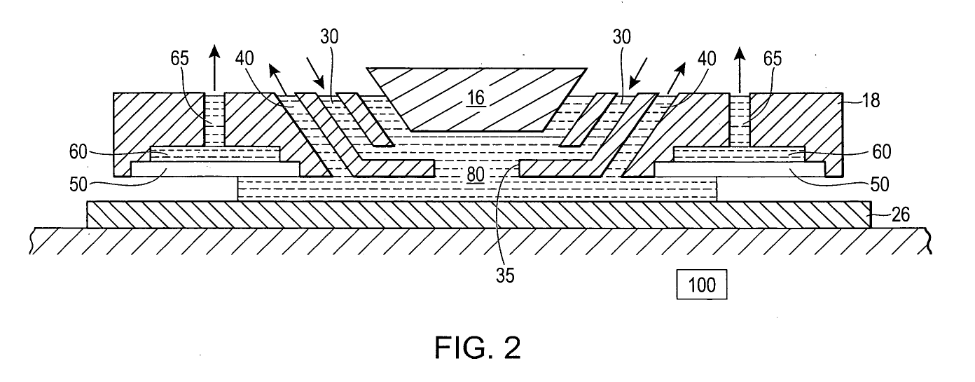

FIG. 2 illustrates an embodiment of an immersion fluid supply and recovery apparatus 18. As shown in FIG. 2, the apparatus 18 maintains immersion liquid 80 in an immersion area, which includes the gap or space between the final optical element 16 of the projection system 14 and a portion of the upper surface of the substrate 26. The immersion liquid 80 in FIG. 2 can be seen as occupying only a portion of the upper surface of the substrate 26. That is, the size of the immersion area is smaller than the size of the upper surface of the substrate 26.

The apparatus 18 includes at least one (and preferably more than one) liquid supply inlets 30 through which immersion liquid 80 is supplied to the immersion area. The liquid reaches the substrate 26 after passing through aperture 35. As shown in FIG. 2, the supply and recovery of the immersion liquid is controlled so that the level of the immersion liquid between the apparatus 18 and the final optical element 16 is maintained above the lower surface of the final optical element 16 so that the exposure light transmitted through the projection system 14 travels only through the immersion liquid (that is, it does not travel through any air or gas) before reaching the substrate 26.

In the FIG. 2 embodiment, the supply and recovery apparatus 18 includes a set of first liquid outlets 40 and a set of second liquid outlets 65. The set of first liquid outlets 40 is located closer to the aperture 35 or the center of the immersion area (which, in the FIG. 2 embodiment, corresponds to the optical axis of the projection system 14) than is the set of second outlets 65. That is, with respect to each direction in the plane of the substrate surface, the first outlets 40 are located a first distance from the aperture 35, the second outlets 65 are located a second distance from the aperture 35, and the second distance is greater than the first distance.

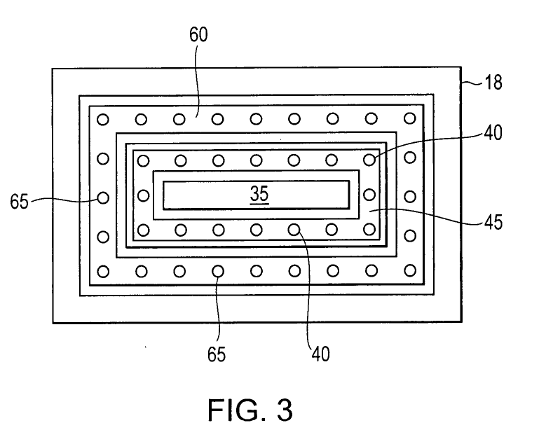

As shown in FIG. 3, according to some embodiments, the set of first outlets 40 end in openings that open into a groove 45 that encircles the aperture 35. Similarly, the second outlets 65 end in openings that open into a groove 60 that encircles the first groove 45 and the aperture 35. Such a structure is effective in recovering immersion liquid regardless of the direction in which the substrate 26 moves, and also is effective in smoothing the flow of immersion liquid so as to avoid turbulence and cavitation.

As shown in FIG. 2, a porous member 50 covers the second outlets 65 (in particular, it covers the groove 60 associated with the second outlets 65). The porous member 50 can be a mesh, a porous material such as a sponge or a member having holes etched therein. The member can be, for example, glass, metal, ceramics or plastic. See, for example, US2007/0046910 A1, the disclosure of which is incorporated herein by reference in its entirety.

The pore size of the pores in the porous member preferably is about 5 μm to 125 μm. Smaller pore sizes are preferred because a smaller pore size increases the bubble point of the porous member, which, in turn, reduces the chances of gas being sucked through the porous member 50. Sucking gas through the porous member 50 (or through any of the first or second outlets) is not desirable because such gas can cause vibrations and temperature fluctuations, which adversely affects the image forming performance of the lithography apparatus 10.

A control system 100 controls the supply and temperature of immersion liquid into the immersion area through inlets 30 and controls the recovery of immersion liquid from the immersion area through outlets 40 and 65.

In particular, the control system 100 applies a first low pressure to the first outlets 40 and applies a second low pressure to the second outlets 65. The low pressure applied to the first outlets 40 is such that more than 50% of the total liquid recovered is recovered through the set of first outlets 40. The first low pressure can be controlled to be a fixed suction rate, for example, by a vacuum source having a needle valve. Any immersion liquid that has not been recovered by the first set of outlets 40 and flows past the set of first outlets 40 is recovered through the porous member 50 and the set of second outlets 65. As noted above, the porous member 50 could be made out of porous ceramic, sintered glass, chemically etched metal sheets, etc., and would provide a suction area having a high critical bubble point, for example, greater than 2 kPa. The second low pressure supplied to the second outlets 65 can be controlled to be maintained below the bubble point so that no air or other gases is mixed into the recovery system through the porous member 50. Structures for controlling the low pressure supplied to the second outlets can be those systems described, for example, in US2006/0152697A1, the disclosure of which is incorporated herein by reference in its entirety. Control system 100 controls the flow of liquid supplied through the inlet 30 to maintain a desired fluid level in the immersion area by any of numerous known techniques.

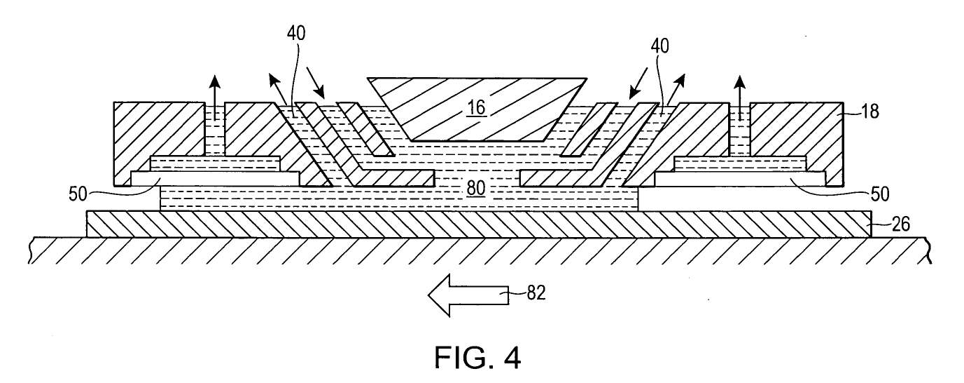

FIG. 4 shows the manner in which the immersion liquid on the substrate 26 moves when the substrate 26 moves in the direction of arrow 82 in FIG. 4. Although the immersion liquid 80 may move away from the porous member 50 on one side of the immersion area, the supply and recovery of the immersion liquid can be controlled such that the immersion liquid 80 remains in communication with the set of first outlets 40, and thus no air or other gases becomes mixed with the immersion liquid recovered through the set of first outlets 40.

Recovering more than 50% of the immersion liquid through outlets having no porous member and recovering the remainder through liquid outlets having a porous member is advantageous compared to systems in which all outlets are covered with a porous member or no outlets are covered by a porous member. By removing more than 50% of the immersion liquid through outlets having no porous member, the rate of liquid outflow can be increased. This is beneficial because contaminants from the resist and other sources can be flushed away from under the projection system. The temperature of the immersion liquid also can be better controlled because liquid heated by the exposure energy is quickly removed. Use of a porous member to recover at least some of the immersion liquid also is advantageous because by controlling the removal force so as to be below the bubble point of the porous member, gas is not sucked through the outlets. However, if all liquid is removed through the porous member, then the pore size of the porous member must be increased in order to achieve the needed recovery rate so as to avoid an overflow condition. However, increasing the pore size reduces the bubble point, thereby increasing the chances that gases will be recovered through the porous member, which leads to vibration. Furthermore, removing all liquid through the porous member makes it more difficult to control the immersion liquid temperature and purity.

According to these aspects of the invention, because more than half of the immersion liquid is recovered through the first outlets having no porous member, the flow rate through the second outlets having the porous member can be greatly reduced. Accordingly, the porous member can have a smaller pore size and thus a higher bubble point. The control of vacuum pressure through a porous member with a higher bubble point is easier than control through a porous member having a lower bubble point. In addition, pressure fluctuation caused by change of flow rate through the porous member is reduced because of the slower rate and higher bubble point. A porous member having a higher bubble point also prevents the liquid from flowing back down onto the substrate even if the vacuum pressure is lost above the porous member.

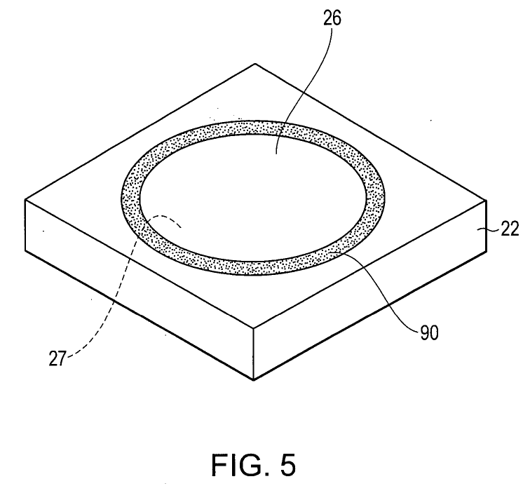

FIG. 5 shows an embodiment in which the substrate-holding stage (or table) includes a porous member 90 adjacent to the area where the substrate is held. The embodiment of FIG. 5 provides the porous member 90 on the fine movement stage 22.

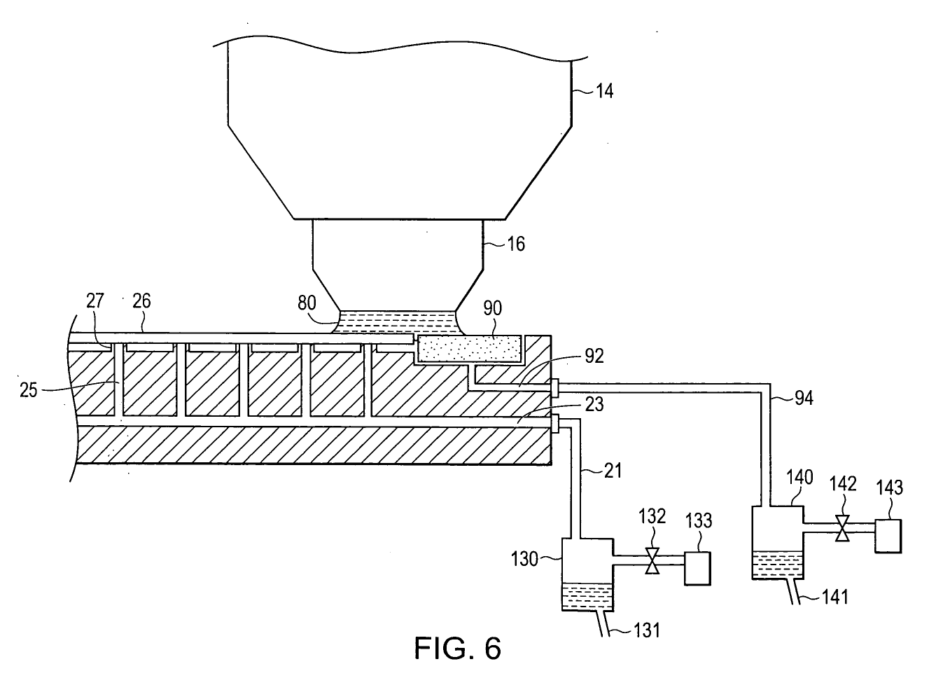

The porous member 90 is a liquid-absorbing member that is disposed directly adjacent to the substrate 26, which is held on a holder 27 (sometimes called a “chuck”). The porous member 90 is annular and is arranged in a groove (shown in FIG. 6) that encircles the holder 27. A passage 92, which is continued to the groove, is formed in the stage 22. Thus, the bottom of the porous member 90 arranged in the groove is connected to the flow passage 92. The porous member 90 can be, for example, a porous material such as porous ceramics. Alternatively, a sponge or a sponge-like material can be used as the porous member 90.

In one embodiment, the porous member 90 has a thickness such that its upper surface is substantially in the same plane as the upper surface of the substrate 26 when held on the holding member 27. In other embodiments, the porous member 90 may be thicker or thinner so that its upper surface is either above or below the substrate upper surface. As seen in FIG. 6, the stage 22 includes internal passages 25 that function as the substrate holder 27 when a vacuum is applied to these passages 25 via passage 23. In particular, the upper end of each passage 25 opens in a projection on which the lower surface of the substrate 26 rests. The passage 23 is communicated with tubing 21 that in turn is connected to a tank 130 that communicates with a vacuum pump 133 via valve 132. In addition, a discharge passage 131 allows any immersion liquid collected through passage 23 to be disposed of or recirculated. Immersion liquid can enter passage 23 if the immersion liquid reaches the lower surface of the substrate 26 and then is sucked into the openings of passages 25. In FIG. 6, an immersion liquid confinement apparatus or an immersion fluid supply and recovery apparatus is omitted.

Providing the porous member 90 so that it is directly adjacent to the outer edge of the substrate 26 greatly reduces the possibility of immersion liquid reaching the lower surface of the substrate 26. Thus, even if the substrate stage 22 is moved to a location where part of the immersion area extends beyond the edge of the substrate 26 (which occurs, for example, when imaging portions of the substrate near the outer circumference of the substrate as shown in FIG. 6), porous member 90 is able to collect immersion liquid beyond the outer circumference of the substrate 26. This is advantageous because if a thin film is left on the surface of the wafer stage, it could leave contaminants after the liquid is evaporated. In addition, evaporation results in vapor that could contaminate other systems and can affect the readings taken by the interferometers. Furthermore, evaporation can result in cooling of the wafer stage, causing undesirable deformation. Thus providing the porous member 90 adjacent to the substrate 26 minimizes these effects by promptly removing any immersion liquid that extends beyond the outer circumference of the substrate 26. Moreover, as discussed above, disposing the porous member 90 directly adjacent to the substrate 26 minimizes seepage of immersion liquid below the substrate, and thus minimizes contamination of the substrate holder. Another way to hold the substrate 26 is described in US2006/0139614A1, the disclosure of which is incorporated herein by reference in its entirety.

As shown in FIG. 6, the passage 92 that communicates with the porous member 90 is connected to tubing 94 that leads to receptacle 140. A vacuum pump 143 communicates with receptacle 140 or tank via valve 142. In addition, immersion liquid collected in the receptacle is discharged through discharge passage 141 where it can be disposed of or recirculated. See, for example, US2005/0219488, the disclosure of which is incorporated herein by reference in its entirety.

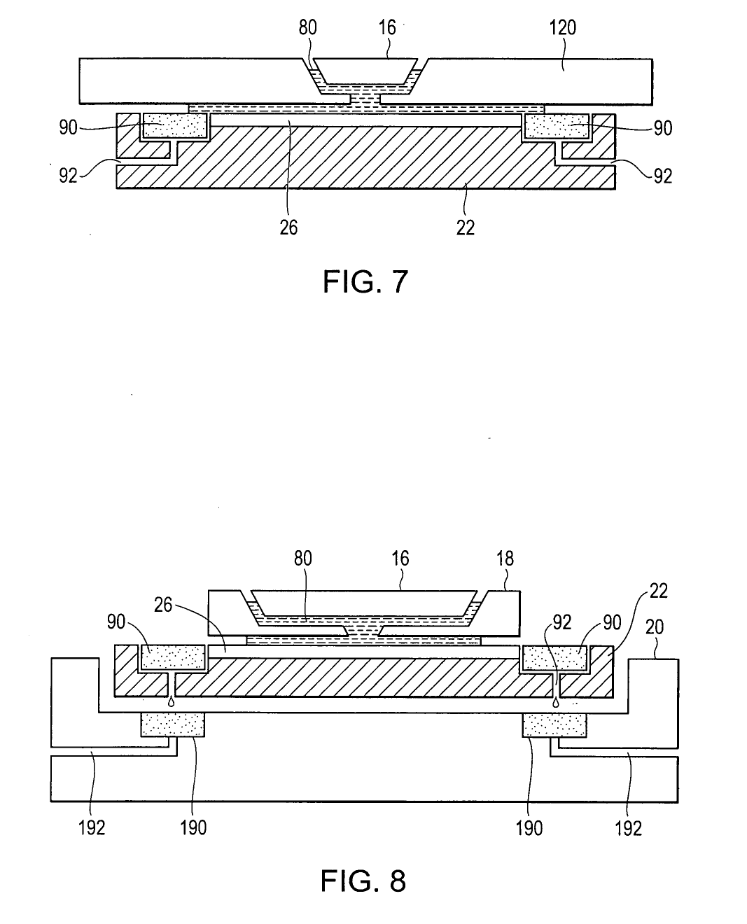

FIG. 7 shows an embodiment in which the immersion liquid supply system is a “bath-type” system in which the entire upper surface of the substrate 26 is covered in immersion liquid. The immersion liquid supply system includes a confinement plate 120 that maintains a layer of immersion liquid 80 on the entire upper surface of the substrate 26. The plate 120 is sufficiently large to cover the entire upper surface of the substrate 26 and to maintain the entire upper surface of the substrate 26 submerged in the immersion liquid during the exposure. The porous member 90 is particularly useful in this bath-type system for collecting the immersion liquid that flows beyond the outer circumference of the substrate 26. An example of the “bath-type” system is described in U.S. patent application Ser. No. 11/523,595, the disclosure of which is incorporated herein by reference in its entirety.

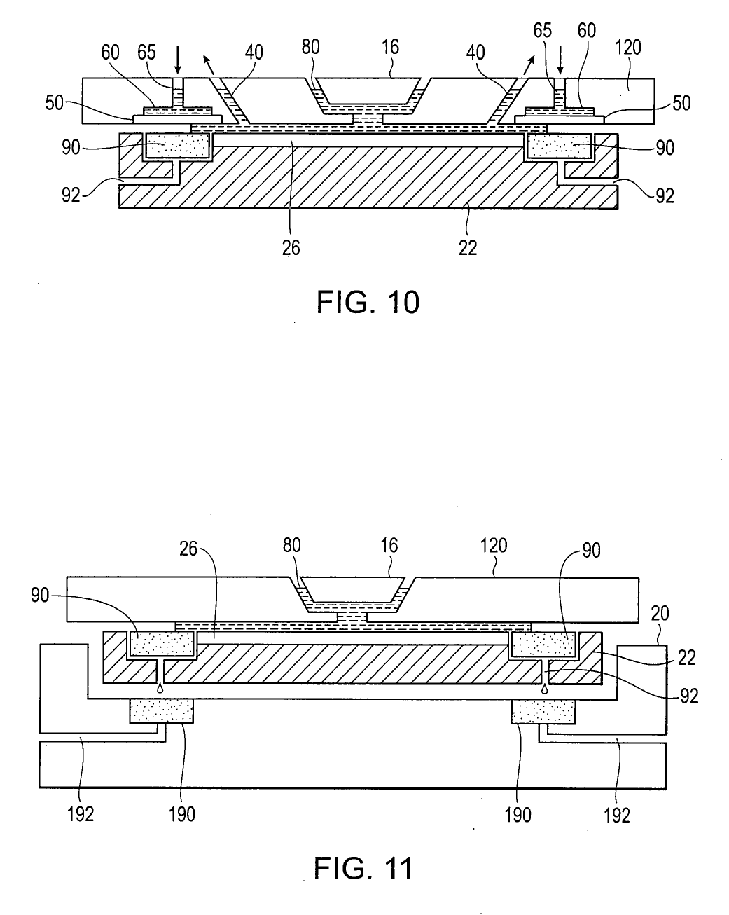

The “bath-type” arrangement of FIG. 7 can be modified as shown in FIG. 10 so that the confinement plate 120 includes first and second outlets 40 and 65 similar to the arrangement of FIG. 2, with the second outlet 65 covered by a porous member 50 and the first outlet 40 not covered by any porous member. The control system 100 (shown in FIG. 2) controls the recovery of immersion liquid through the outlets 40 and 65 so that the entire upper surface of the substrate 26 is covered by the immersion liquid during the exposure. For example, more than 50% of supplied immersion liquid may be recovered from the outlets 40 and the rest of the supplied immersion liquid may be recovered through the outlets 65 and the porous member 90. Providing outlets (particularly the porous-member-covered second outlet 65) on the confinement plate 120 is advantageous in that it can prevent a thin film of the immersion liquid from forming on portions of the lower surface of the confinement plate 120 outside of the immersion area. In the embodiment of FIG. 10, more liquid can be removed through the first outlet 40 than through the second outlet 65, as in the FIG. 2 embodiment, although it is not necessary to remove as much liquid through the outlets 40 and 65 due to the operation of the porous member 90 on the stage 22. Furthermore, more liquid can be removed through the outlets (40, 65) and the porous member 90, and thus more liquid can be supplied. Therefore, the temperature change of the immersion liquid filled in the space between the confinement plate 120 and the substrate 26 can be suppressed, and the high purity of the immersion liquid can be maintained.

FIG. 8 shows another embodiment that is somewhat similar to the embodiment of FIGS. 5 and 6 except that the liquid collection tubing is not attached to the fine stage 22. Instead, immersion liquid collected in the porous member 90 passes by gravity through passages 92 and then is collected by a second porous member 190 disposed in the coarse substrate stage 20. A passage 192 in the coarse substrate stage communicates with the second porous member 190, and that passage 192 can be connected to tubing such as the tubing 94 shown in FIG. 6, which also is connected to a receptacle and/or vacuum source.

The embodiment of FIG. 8 can be used with a local-type immersion liquid supply system (as shown in FIG. 8) in which the immersion area is formed over an area that is smaller than the surface of the substrate 26. The FIG. 8 system (used with a local-type or a bath-type immersion liquid supply system) is advantageous because no tubing is connected to the fine substrate stage 22. Having a tube connected to the fine stage can affect the motion of the fine stage because the tube has a certain stiffness and mass.

FIG. 11 shows a system similar to the FIG. 8 system, but using a bath-type immersion liquid supply system as described with respect to FIG. 7. In FIG. 11, the confinement plate 120 may include first and second outlets 40 and 65 similar to the arrangement of FIG. 10.

In certain embodiments, the immersion fluid is a liquid having a high index of refraction. In different embodiments, the liquid may be pure water, or a liquid including, but not limited to, cedar oil, fluorin-based oils, “Decalin” or “Perhydropyrene.”

The porous members 90 and 190 may be a mesh or may be formed of a porous material having holes typically with a size smaller than 150 μm. For example, the porous member may be a wire mesh including woven pieces or layers of material made of metal, plastic or the like, a porous metal, a porous glass, a porous plastic, a porous ceramic, or a sheet of material having chemically etched holes (for example, by photo-etching).

The use of the exposure apparatus described herein is not limited to a photolithography system for semiconductor manufacturing. The exposure apparatus, for example, can be used as an LCD photolithography system that exposes a liquid crystal display device pattern onto a rectangular glass plate, or a photolithography system for manufacturing a thin film magnetic head.

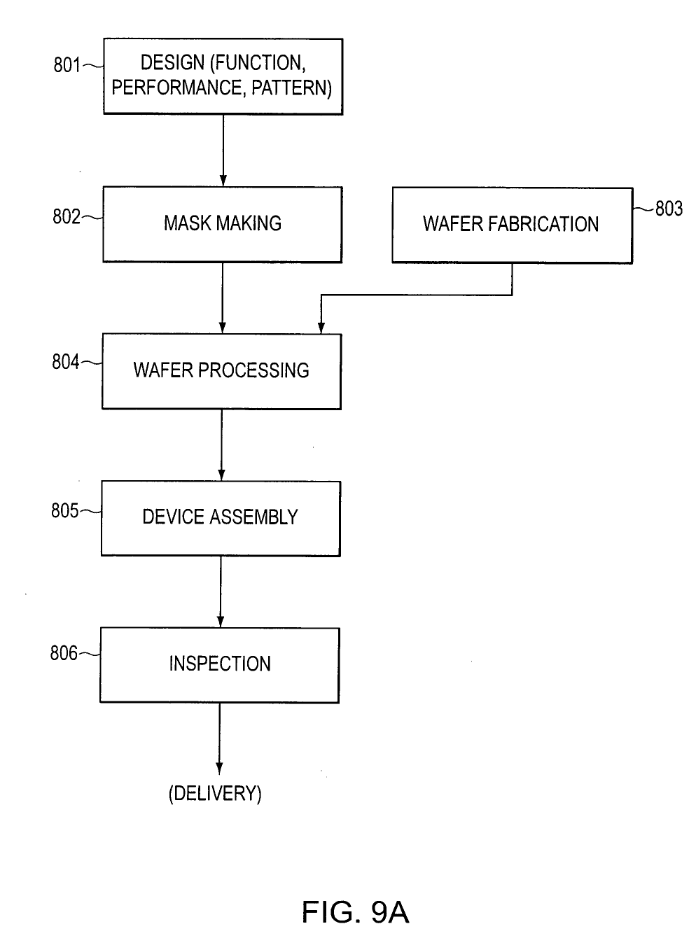

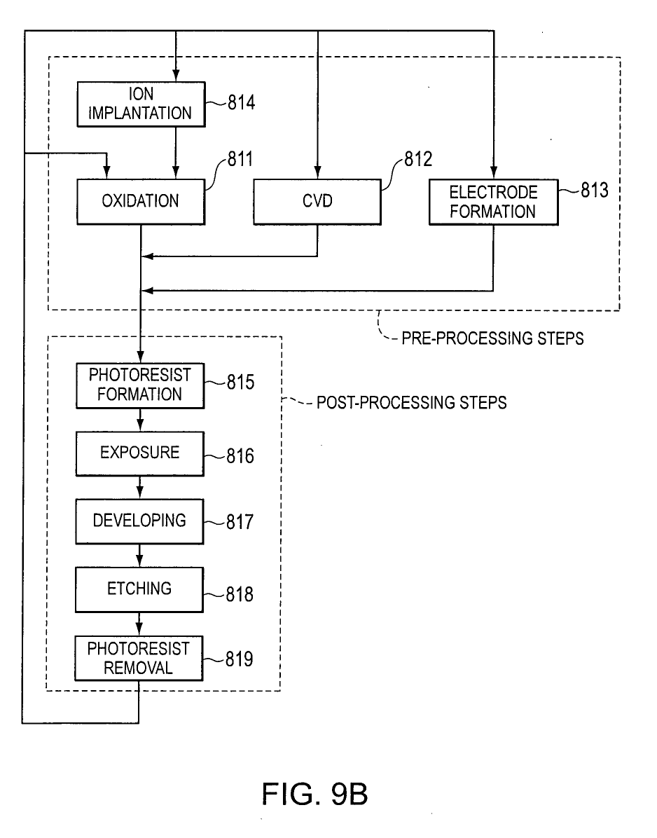

Semiconductor devices can be fabricated using the above described systems, by the process shown generally in FIG. 9A. In step 801 the device's function and performance characteristics are designed. Next, in step 802, a mask (reticle) having a pattern is designed according to the previous designing step, and in a step 803, a wafer is made from a silicon material. The mask pattern designed in step 802 is exposed onto the wafer from step 803 in step 804 by a photolithography system described hereinabove in accordance with aspects of the invention. In step 805, the semiconductor device is assembled (including the dicing process, bonding process and packaging process). Finally, the device is then inspected in step 806.

FIG. 9B illustrates a detailed flowchart example of the above-mentioned step 804 in the case of fabricating semiconductor devices. In FIG. 9B, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 815 (photoresist formation step), photoresist is applied to a wafer. Next, in step 816 (exposure step), the above-mentioned exposure device is used to transfer the circuit pattern of a mask (reticle) to a wafer. Then in step 817 (developing step), the exposed wafer is developed, and in step 818 (etching step), parts other than residual photoresist (exposed material surface) are removed by etching. In step 819 (photoresist removal step), unnecessary photoresist remaining after etching is removed. Multiple circuit patterns are formed by repetition of these preprocessing and post-processing steps.

A photolithography system (an exposure apparatus) according to the embodiments described herein can be built by assembling various subsystems in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes providing mechanical interfaces, electrical circuit wiring connections and air pressure plumbing connections between each subsystem. Each subsystem also is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

While the invention has been described with reference to preferred embodiments thereof, it is to be understood that the invention is not limited to the preferred embodiments or constructions. The invention is intended to cover various modifications and equivalent arrangements. In addition, while the various elements of the preferred embodiments are shown in various combinations and configurations, that are exemplary, other combinations and configurations, including more, less or only a single element, are also within the spirit and scope of the invention.

What is claimed is:

1. An immersion liquid confinement apparatus for confining an immersion liquid in an immersion area that includes a gap between a projection system and an object of exposure in an immersion lithography system, the apparatus also recovering the immersion liquid from the immersion area, the apparatus comprising:
a confinement member that includes a first outlet, a second outlet and an aperture through which a patterned image is projected onto the object, the second outlet being disposed radially farther away from the aperture than the first outlet, the second outlet being covered by a porous member, the first outlet being not covered by any porous member; and
a pressure control system that controls (i) a first low pressure provided to the first outlet so that more than 50% of recovered immersion liquid is recovered through the first outlet, and (ii) a second low pressure provided to the second outlet, the second low pressure maintains a pressure at a surface of the porous member below a bubble point of the porous member.

2. The apparatus of claim 1, wherein the second outlet includes a groove.

3. The apparatus of claim 2, wherein the first outlet includes a groove.

4. The apparatus of claim 1, wherein the first outlet includes a groove.

5. The apparatus of claim 2, wherein the groove of the second outlet and the porous member encircle the immersion area.

6. The apparatus of claim 3, wherein the groove of the first outlet encircles the aperture and the groove of the second outlet and the porous member encircle the aperture and the groove of the first outlet.

7. The apparatus of claim 1, wherein the second outlet includes a plurality of openings that encircle the aperture and the porous member also encircles the aperture.

8. The apparatus of claim 7, wherein the first outlet includes a plurality of openings that encircle the aperture.

9. The apparatus of claim 1, wherein the first outlet includes a plurality of openings that encircle the aperture.

10. The apparatus of claim 1, wherein a pore size of pores in the porous member is between about 5 microns and about 125 microns.

11. The apparatus of claim 1, wherein the immersion lithography system is a scanning exposure system that moves the object in a scanning direction during exposure of the object.

12. The apparatus of claim 1, wherein the porous member is one of a mesh, a porous material and a member having etched holes therein.

13. The apparatus of claim 1, wherein the confinement member includes at least one immersion liquid supply opening that supplies the immersion liquid to the immersion area, the at least one supply opening disposed closer to the aperture than are the first and second outlets.

14. The apparatus of claim 1, wherein the immersion area is smaller than an area of a surface of the object to be subjected to exposure.

15. The apparatus of claim 1, wherein the confinement member has an area that is greater than an area of the object to be subjected to exposure, and the immersion area is greater than the area of the surface of the object to be subjected to exposure.

16. The apparatus of claim 15, further comprising an object table that movably holds the object adjacent to the projection system with the gap between the projection system and the object, the object table including a holding area on which the object is held and a porous liquid collection member adjacent to the holding area.

17. An immersion lithography system for transferring an image onto an object, the immersion lithography system comprising:
a projection system;
a stage for holding the object, the projection system forms the image on the object held by the stage;
an immersion fluid supply system that supplies an immersion liquid to form an immersion area which includes a gap between the projection system and the object held by the stage; and
the apparatus of claim 1 for confining and recovering the immersion liquid.

18. A process for manufacturing a device comprising:
providing an object;
exposing the object by transferring an image onto the object utilizing the immersion lithography system of claim 17; and
developing the exposed object.

19. A method of recovering a liquid from an immersion area which includes a gap between a projection system and an object of exposure in an immersion lithography system, the method comprising:
recovering at least some of the immersion liquid with a first outlet disposed a first distance from an aperture through which a patterned image is projected onto the object, the first outlet being not covered by any porous member;
recovering immersion liquid with a second outlet that is covered by a porous member, the second outlet and the porous member disposed a second distance from the aperture, the second distance is greater than the first distance; and
controlling a first low pressure provided to the first outlet so that more than 50% of recovered immersion liquid is recovered through the first outlet, and controlling a second low pressure provided to the second outlet, the second low pressure maintains a pressure at a surface of the porous member below a bubble point of the porous member.

20. The method of claim 19, wherein the second outlet includes a groove.

21. The method of claim 20, wherein the first outlet includes a groove.

22. The method of claim 19, wherein the first outlet includes a groove.

23. The method of claim 20, wherein the groove of the second outlet and the porous member encircle the aperture.

24. The method of claim 21, wherein the groove of the first outlet encircles the aperture and the groove of the second outlet and the porous member encircle the aperture and the groove of the first outlet.

25. The method of claim 19, wherein the second outlet includes a plurality of openings that encircle the aperture and the porous member also encircles the aperture.

26. The method of claim 25, wherein the first outlet includes a plurality of openings that encircle the aperture.

27. The method of claim 19, wherein the first outlet includes a plurality of openings that encircle the aperture.

28. The method of claim 19, wherein a pore size of pores in the porous member is between about 5 microns and about 125 microns.

29. The method of claim 19, wherein the porous member is one of a mesh, a porous material and a member having etched holes therein.

30. The method of claim 19, further comprising supplying the immersion liquid to the immersion area through at least one supply opening disposed closer to the aperture than are the first and second outlets.

31. The method of claim 19, wherein the immersion area is smaller than an area of a surface of the object to be subjected to exposure.

32. The method of claim 19, wherein the first and second outlets are disposed in a confinement member that has an area that is greater than an area of the object to be subjected to exposure, and the immersion area is greater than the area of the surface of the object to be subjected to exposure.

33. The method of claim 32, wherein the object is held by an object table that movably holds the object adjacent to the projection system with the gap between the projection system and the object, the object table including a holding area on which the object is held, immersion liquid being further collected by a porous liquid collection member adjacent to the holding area on the object table.

34. An immersion liquid confinement apparatus for confining an immersion liquid in an immersion area that includes a gap between a projection system and an object of exposure in an immersion lithography system, the apparatus also recovering the immersion liquid from the immersion area, the apparatus comprising:
a confinement member that encircles the immersion area, the confinement member including a first outlet and a second outlet, the second outlet disposed radially farther away from a center of the immersion area than the first outlet, a porous member disposed to cover the second outlet, the first outlet is not covered by any porous member, the confinement member has a lower surface that is greater than an entire upper surface of the object to be subjected to exposure, and the entire upper surface of the object being constantly submerged in the immersion liquid during the exposure; and
an object table that movably holds the object adjacent to the projection system with the gap between the projection system and the object, the object table including a holding area on which the object is held and a porous liquid collection member adjacent to the holding area.

35. The apparatus of claim 34, further comprising:
a pressure control system that controls (i) a first low pressure provided to the first outlet so that more than 50% of recovered immersion liquid is recovered through the first outlet, and (ii) a second low pressure provided to the second outlet, the second low pressure maintains a pressure at a surface of the porous member below a bubble point of the porous member.

36. An immersion liquid confinement apparatus for confining an immersion liquid in an immersion area that includes a gap between a projection system and an object of exposure in an immersion lithography system, the apparatus also recovering the immersion liquid from the immersion area, the apparatus comprising:
a confinement member that encircles the immersion area, the confinement member has an area that is greater than an area of the object to be subjected to exposure, and the immersion area is greater than the area of the surface of the object to be subjected to exposure;
a fine-movement table that movably holds the object adjacent to the projection system with the gap between the projection system and the object, the fine-movement table including a holding area on which the object is held, a first porous liquid collection member adjacent to the holding area, and a liquid flow passage extending from the first porous liquid collection member to a liquid exit on a surface of the fine-movement table; and
a coarse-movement table disposed below the fine-movement table, the coarse-movement table including a second porous liquid collection member that opposes the liquid exit of the fine-movement table to receive the liquid from the liquid exit of the fine-movement table.

37. An immersion lithography system for transferring an image onto an object through an immersion liquid, the immersion lithography system comprising:
a confinement member that has a lower surface that is greater than an entire upper surface of the object to be subjected to exposure, the entire upper surface of the object being submerged in the immersion liquid during the exposure;
a table that movably holds the object adjacent to the projection system with a gap between the projection system and the object, the table including a holding area on which the object is held, a first porous liquid collection member adjacent to the holding area, and a liquid flow passage extending from the first porous liquid collection member to a liquid exit on a surface of the table; and
a second porous liquid collection member that receives the liquid from the liquid exit of the table when the second porous liquid collection member opposes the liquid exit of the table.

38. The apparatus of claim 37, further comprising:
a stage assembly by which the table is moved, wherein the second porous liquid collection member is provided at the stage assembly.
